(19) United States
(12) Patent Application Publication
(10) Pub. No.: US 2009/0304987 A1
(43) Pub. Date: Dec. 10, 2009

(54) METHOD AND APPARATUS FOR MANUFACTURING THERMOFORMED COMPONENTS COMPRISING A CORE BETWEEN CONTINUOUS FILMS

(76) Inventor: John Cloughley, Stockport (GB)

Correspondence Address: MYERS BIGEL SIBLEY & SAJOVEC, PO BOX 37428, RALEIGH, NC, 27627, US

(21) Appl. No.: 12/442,246

(22) PCT Filed: Sep. 21, 2007
(86) PCT No.: PCT/GB07/03600

§ 371 Date: Jul. 14, 2009

(30) Foreign Application Priority Data
Sep. 21, 2006 (GB) 0618608.4

(51) Int. Cl. B32B 3/12; C09J 5/06

(52) U.S. Cl. 428/116; 156/243

(57) ABSTRACT

Method and apparatus are described for making e.g. panels by thermoforming outer films (20, 21) to a cellular core (5). The core is formed in a first step by corrugating and moulding together two thermoplastics sheets (12, 13), and then the films (20, 21) bonded in a press (26). The panel (28) produced may be suitable for use as a door A plurality of cores may be formed in series or in parallel and united to form a multilayer core, which may provide for a range of functions including water and electrical services and heat transfer

This invention relates to building and other components and to their manufacture and apparatus for their manufacture.

Building components such as panels for walls and doors commonly comprise a core of press board, chip board, plasterboard or timber, which may be faced with a laminate such as a wood veneer, or a protective plastics layer. Other components such as skirting boards, dado rails, and components for use with glass work such as in conservatories, are continuously extruded from plastics or metal.

There is known, for the manufacture of such items as soles in footwear, the process of thermoforming wherein two sheets of thermoplastic material are formed between shaped press plates to produce a structure enclosing voids filled with air. It is also known in principle, e.g. from U.S. Pat. No. 5,885,691 to produce reinforced twin-sheet thermoformed articles wherein an insert is placed on a lower sheet in a mould, and pressing the upper sheet onto the insert so that the heated sheets and inserts are fused and shaped as desired.

This simple basic thermoforming process however does not have the versatility required to enable a wide variety of structured components to be produced.

It is an object of the invention to provide a process based on thermoforming, which is capable for being used to produce a wide variety of building and other components, components made by the method, and apparatus for carrying out the method.

According to the invention, a method for making components comprises feeding a continuous film to be coated on the facing surfaces with an adhesive, and thermoforming the film on a thermoforming press.

Preferably, a continuous or discontinuous core is formed and fed between the facing surfaces of the films, and the films and core are thermoformed together.

In a first embodiment, the core may be fed as discontinuous core elements such as pre-manufactured door or other panels, which are inserted between the film webs by a program controlled manipulation means, such as a so called ‘robotic’ device. This may comprise an arm with a plurality of articulation joints and a work-piece clamp, of known kind.

Advantageously, the core may be produced in a preliminary step of the method, by bringing together two webs of thermoplastic material coated with polyurethane, in a further thermoforming or pressing step to produce a cellular core structure containing voids. This process can be repeated an indefinite number of times to produce a complex multilayer structure, and incorporate layers of differing materials for differing requirements, and with a variety of different arrangements of voids.

After bonding the film to the outer surfaces of the core, the article produced may be trimmed, cut into appropriate lengths, and stacked for storage or transportation.

The edges of the thermoforming press plates may be sealed along the longitudinal edges by a rib at each side, which can be adjusted in position laterally of the plate to accommodate various work-piece widths. The ends of the press plates may also be sealed by means of a lip extending along each end, transversely of the plate.

The core may in one embodiment be initially formed by corrugating the two webs in such a way that the resulting core provides voids connected by webs. In the next thermoforming stage, air pressure may be applied through a gap forced between the webs into the voids which are expanded till the side walls abut each other, and the result is a panel comprising an internal void, subdivided by internal partitions, which act as structural reinforcements.

The voids within the core may be utilized to provide conduits for services such as electrical power, telecommunications and computer connections, heating or cooling water or air circulation. Alternatively the void or air or water filled voids may act passively as thermal or acoustic insulation and in the case of water, as a reservoir of fire suppressant liquid or gas.

The outer films may comprise any thermoplastic, such as ABS, polypropylene or polyethylene terephthalate (PET) film, and the core or core components may be formed from sheets of thermoplastic material coated with a bonding polymer for a reinforcement medium, such as a polyurethane polymer, usually but not invariably unexpanded. This may contain a high filler content of refractories such as CaCO₃; dolomite, or BaSO₄. The polymer may be reinforced with long staple glass fibres, and may include an intumescent to enhance fire-retardant properties.

The outer films may include an intumescent, which may be provided in any or all parts of the component produced.

Apparatus for carrying out the method of the invention includes means for feeding a core structure between a pair of outer films, and a thermoforming press for thermoforming the films and core into an article.

The apparatus may comprise a plurality of thermoforming presses, each arranged to join at least two plastics webs together, to form a core structure or core structure elements. The presses may be arranged in series, with a first core element being added to with further layers at each step, or two or more presses may be provided in parallel, each forming a core structure element, the elements being fed to a final press where they are brought together as a core structure, between the outer films.

The press plattens may be adapted, as by apertures, to allow air to escape from the core structure during forming.

Preferred embodiments of the components according to and made by the method according to the invention, of apparatus for carrying out methods according to the invention, and methods according to the invention carried out thereby, will now be described by way of example, with reference to the accompanying drawings, wherein:

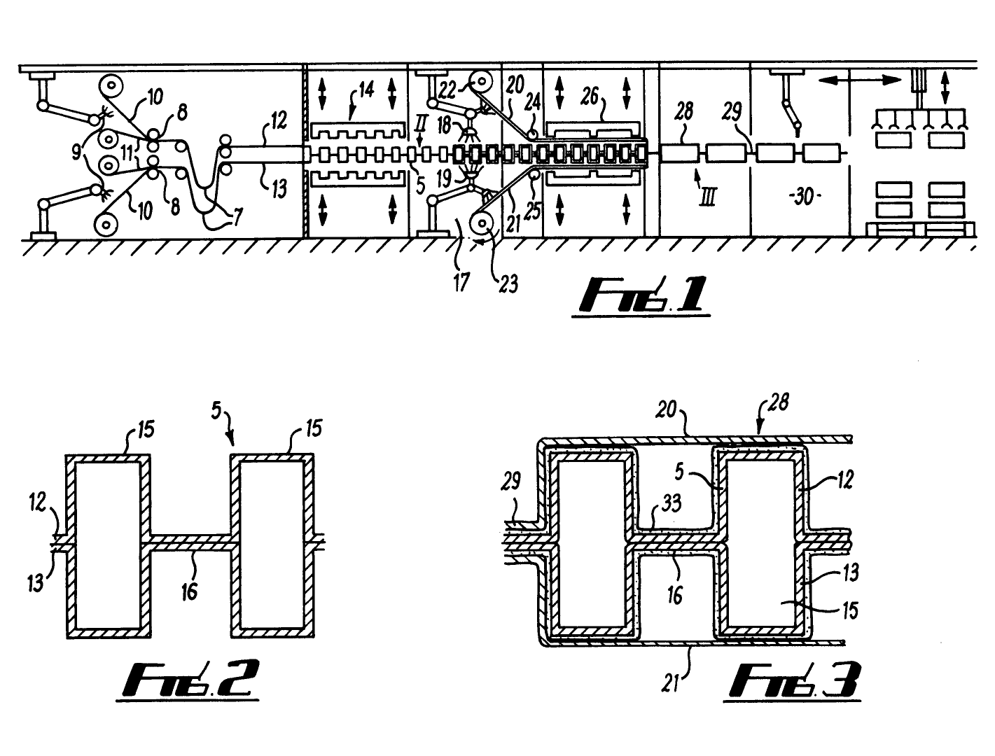

FIG. 1 is a diagrammatic side elevation of apparatus according to the invention for carrying out a method according to the invention;

FIG. 2 is a detailed sectional view of a fragment of an intermediate product at II in FIG. 1;

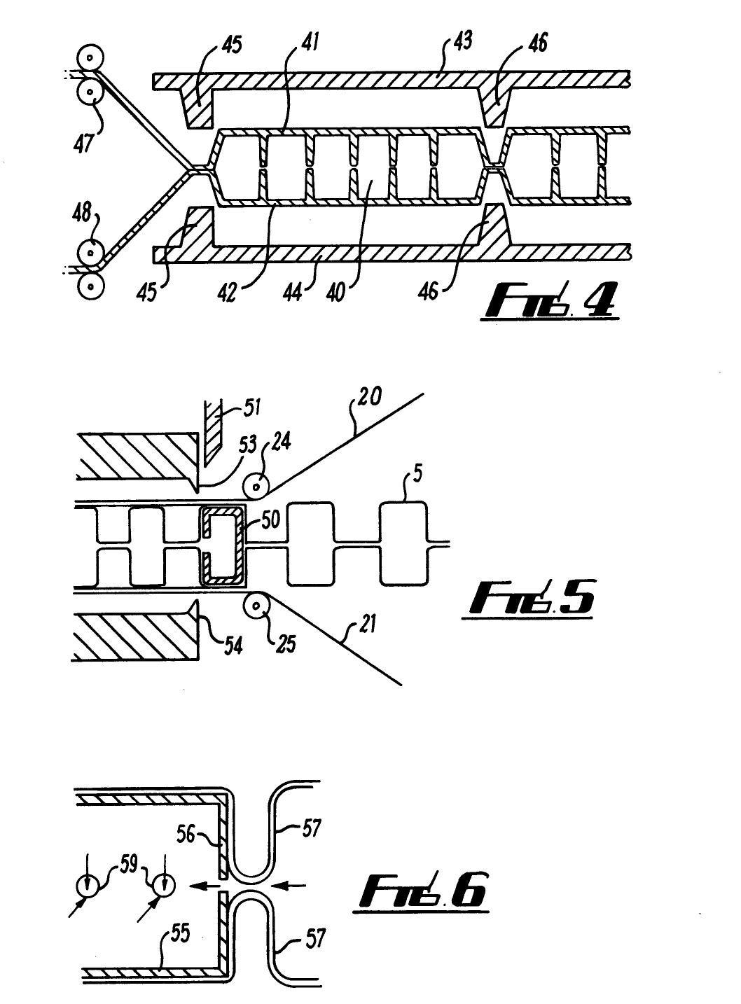

FIG. 3 is a similar view of a fragment of a second intermediate product at III in FIG. 1;

FIG. 4 is a diagrammatic cross-section of the edge region of a thermoforming press as used in FIG. 1;

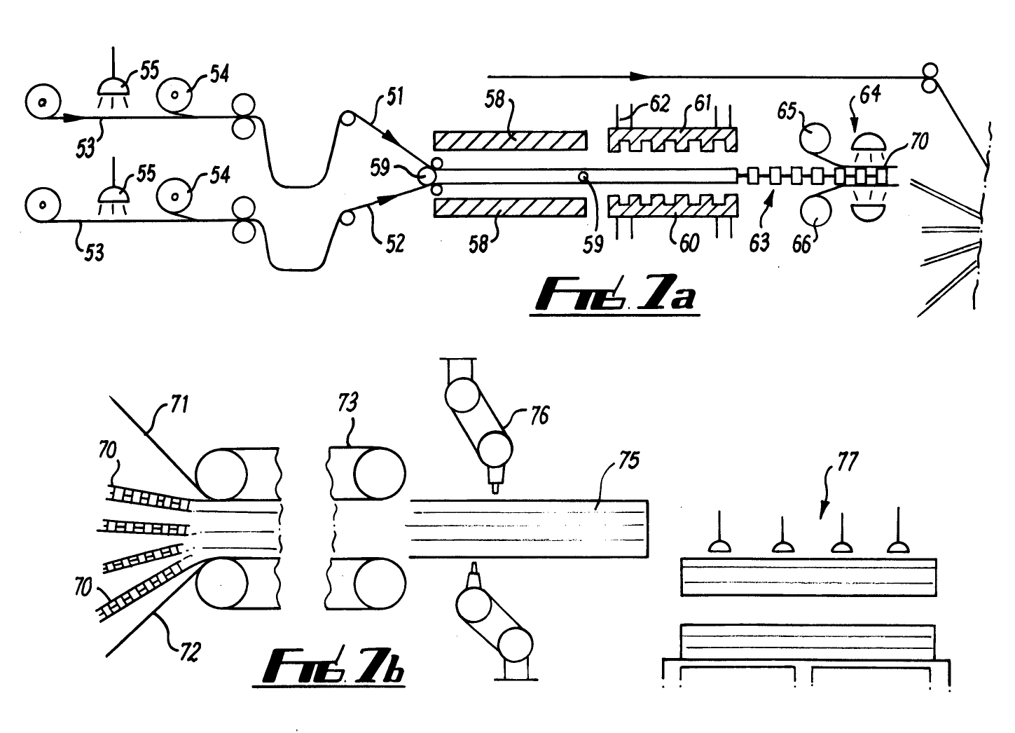

FIG. 5 is a diagrammatic cross-section of the inlet and outlet end of a thermoforming press suitable for use in FIG. 1;

FIG. 6 illustrates introduction of air to a core structure to expand the internal voids;

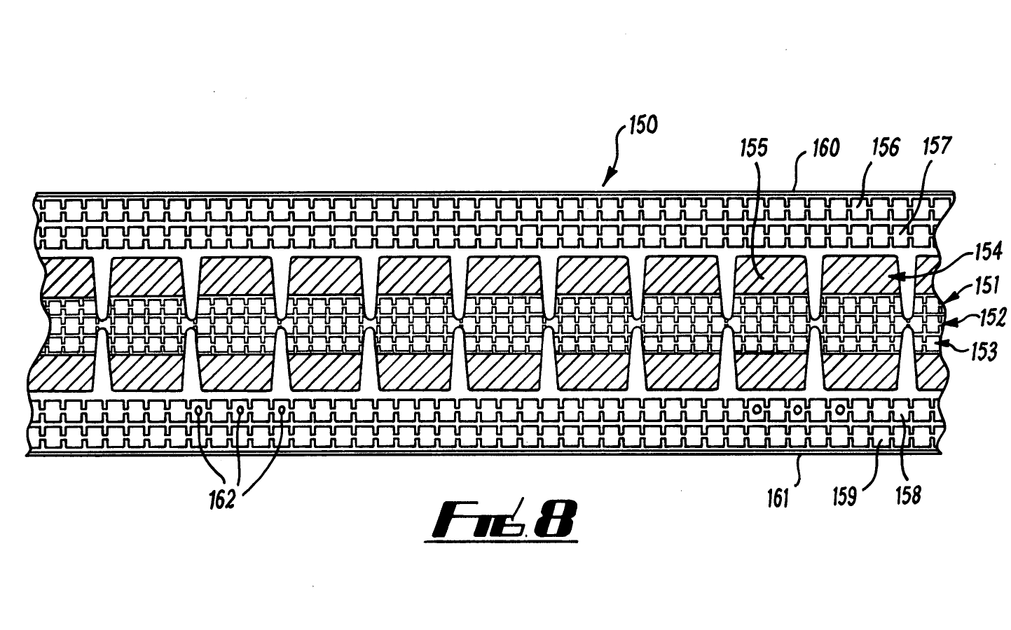

FIG. 7a is a simplified diagram of a first section of apparatus for producing a multi-core composite structure;

FIG. 7b is a second section of such apparatus, and is a continuation of the apparatus of FIG. 7a; and

FIG. 8 is an embodiment of multi-core composite structure, produced by apparatus similar in principle to what is shown in FIG. 7.

In FIG. 1 is shown an apparatus according to the invention which will provide thermoformed articles, such as building panels comprising a cellular core faced with a quality film cladding.

Upper and lower sheets 12, 13 are fed to a first thermoforming press 14. Each sheet is formed prior to this by uniting a facing film 10 to a substrate 11. The respective film 10 is sprayed on its surface which will contact the substrate 11 with a bonding material by nozzles 9, and the film 10 and substrate 11 are brought together at a nip 8. The dispensing and spraying process is continuous, whilst the feed of the sheets 12, 13 to the thermoforming press 14 is intermittent to compensate for which provision is made for slack to form at 7.

The sheets 12, 13 are of a thermoformable material which may be reinforced or filled with glass fibre or other materials to improve performance. This press has upper and lower plates which are formed with ridges and grooves which are aligned groove to groove and ridge to ridge to produce a core composite structure 5 which comprises a series of e.g. parallel rectangular cross-section follow ribs 15 joined by webs 16 where the sheets 12, 13 are brought together. This structure 5 is shown in fragmentary cross-section in FIG. 2.

The structure thus produced is then passed through a spray station 17, where the outer faces of the structure or the outer faces of webs 12, 13 respectively, are optionally sprayed with a layer of an adhesive resin or heated reinforced thermoplastic fibres by spray heads 18, 19 which are mounted on articulated arms, and controlled by a pre-programmed device.

Upper and lower films 20, 21 e.g. of polypropylene or PET are fed from rolls 22, 23 through the spray station, where their respective lower and upper surfaces may optionally be sprayed by the spray heads 18, 19 instead of the faces of the core composite structure 5 and are guided by rollers 24, 25 to the inlet of a second thermoforming press 26 above and below the core structure 5.

The press plates of press 25 are formed with cavities and ribs and cooperate to produce a product comprising panels 28. These are formed with connecting webs 29 which are trimmed at a cutting station 30, from which the panels 28 are fed to be stacked by a vacuum handling device 31 and stacked on a pallet 32 for transport or storage.

A fragmentary cross-section of an end part of a panel 28 before trimming is shown in FIG. 3. This is not to scale as the thickness of the various layers have been exaggerated.

The panel 28 comprises the core structure 5 made up of the layers 12, 13 upon which are provided, on their outersides, a layer of the adhesive resin 33. Alternatively, the films may simply be thermally welded to the core in the press 26.

The films 20, 21 are applied over this, but over the main body of the panel, adhere only to the faces of the hollow ribs 15 of the core structure, and are stretched over the spaces overlying webs 16, except at the ends of the panel, where the films 20, 21 are brought to the nip to form the connecting web 29 (which is trimmed off at the trimming and cutting station 30). This is a temporary structure which is modified in later steps.

FIG. 4, shows a longitudinal edge of a press for forming a panel such as a door, this latter has a core composite 40, with upper and lower films 41 and 42 over its top and bottom surfaces. The press plates 43, 44 are provided with edge members 45 which can be displaced in position to accommodate panels of different widths, and may have lands such as 46 for example moulding decorative inset features.

The edges of the films 41, 42 are guided by pairs of rails 47, 48. The excess film remaining outside the nip of members 45 is removed at the trimming station.

FIG. 5 shows a variation on the feed end of the second press 25 of FIG. 1. The core composite 5 is fed towards the nip of the plates. The upper and lower films 20, 21 are guided into the press by rollers 24, 25. At the designated end of each panel, a rigid inner core member 50 has been inserted from the side and trapped between the films or moulded in place at the first moulding press 14, to lie in the end hollow rib 15 of the core structure, and upper and lower clamping bars 51, 52 are closed to hold the composite while the press is closed. The member 50 may be hollow or a pre-formed foam block and may be needed to support the core from the closing pressure of the plates and the air pressure once the plates are closed. The edges of the press plates are each provided with a closing lip 53, 54. This presses the skins 20, 21 against the core and member 50. In some cases the clamp bars 51, 52 will not be needed as the lips perform this adequately. The lips provide a vacuum seal when heating has softened the skins enough for thermoforming. Provision of the core 50 means that no internal frame is needed to keep sheets 20, 21 apart during moulding, and mouldings and honeycombs can pass through the moulding station unencumbered, and provides resistance to pressure from the clamp bars 51, 52 ensuring a good vacuum in the product.

FIG. 6 shows in cross-section an edge region of a panel press, where a core cavity 55 is defined by a wall 56, with a film 57 adhered to the outer surfaces thereof. The upper and lower films 57 are brought together at edge nip 58, and excess material extends beyond the sides of the panel.

Air pressure is introduced from the side through the nip of the films 57, into the cavity 55. The air escapes from the cavity into adjacent cavities by holes 59, to swell the cavities until they abut as in FIG. 4, closing the voids between adjacent ribs, in a structure initially similar to FIG. 3. The voids may instead be at least partially evacuated to provide thermal and sound installation. A metallic or metallized reflective material may be used to improve their heat reflectivity.

FIGS. 7a and 7b are diagrams showing first and second parts of a continuous process for manufacturing a multi-core panel structure in accordance with the invention, and form two parts of a single continuous diagram. The diagram is grossly simplified in that not all of the feed lines are illustrated, only one core being shown from its formation to inclusion in a nip press for joining with a plurality of other cores.

FIG. 7a thus shows the formation of a single core, by a process essentially similar to that illustrated in FIG. 1. That is, first and second sheets 50, 51 are each prepared by uniting a first material 53 to a second material 54 by selectively spraying the first material with a reinforcement material at 55. This can be a polyurethane-glass, or carbon fibre-glass or polypropylene-glass, or natural fibre and polyurethane or nano-material reinforcement. The material may either be thermosetting or a thermoplastic, or a UV curing material.

The second material is laid on the first material to form a sandwich construction, and pressed at nip 56, with air being expelled. This step is a continuous process, but the next moulding step is a discontinuous process, so a slack is allowed to form in advance of a guide roll 57, to be taken up at each feed step of a thermoforming press 59.

The sandwiches 51, 52 are presented one above the other at the inlet of pre-heater apparatus, which takes the form of a pair of heating devices 58 for each pair of sheets 51, 52 in the form of heating plattens or IR emitters. The heating devices 58 are arranged in a staked array, which is not shown.

At or immediately before the inlet to the pre-heater apparatus, means is provided to insert a mechanical or electrical valve assembly 59 between the sheets 51, 52 so that they will be included in the finished core after moulding. This valve assembly is held in place by a clamp frame and is bonded or welded into the core structure. The assembly 59 acts as a spacer between the sheets 51, 52 during heating and moulding to ensure that they are not prematurely welded together. Positive air pressure is applied between the sheets and is prevented from escaping from the core by the valves 59 at each end. The valves 59 may in use be opened and closed electrically to provide desired functions through the composite to be produced at the end of the process.

After passing through the heaters 58, the sheets are introduced into a moulding station comprising opposed mould plates 60, 61, provided with ribs and channels to form the cellular core structure. The ribs of the plates are in register and press the contacted parts of the sheets 51, 52 together, whilst the channels allow a volume to remain between the sheets 51, 52. The moulds are provided in a stack with a pair of mould plates 60, 61 for each pair of sheets 51, 52. The moulds ride on columns 62 of a parallel tooling stack.

When the mould is closed, air pressure is introduced into the core of each cellular structure to the point where this exerts opening direction pressure on the mould plates 60, 61. To prevent premature opening, each pair of plates has a mould locking system.

Components can be introduced by robotic manipulation between the sheets prior to closure of plates 60, 61 in order to introduce functional parts into the cellular cores.

After moulding, the cellular core may be passed through a station 63 where further components are introduced for example by depositing into the channels between the hollow elements, and another station 64 may optionally apply woven or nonwoven textile reinforcement prior to application of outer webs to the core. Upper and lower rolls 65, 66 each dispense a sheet which is laid on the upper and lower surface of the core, to complete the cellular structure for example as in FIG. 3, and also encapsulate any components placed in the channels.

The completed cellular core 70 is then fed, with a plurality of other cores 70, and outer facing films 71, 72, to the nip of a press apparatus 73. The films 71, 72 may if required be moulded in the parallel tooling stack.

This may take the form of a fixed single vertical press, a moving vertical press, or a moving belt press as shown. This unites the cores, and outer skin films into a composite panel structure 75, which is cut into lengths and trimmed at a robotic trimming station 76 and then stacked for packaging and/or storage and despatch at a stacking station 77.

The films 71, 72 treated at the moulding press 60 to provide either an ‘A class’ smooth finish, or a textured ‘B class’ finish, using alternative mould plates.

FIG. 8 shows a cross sectional view, not to scale, of an embodiment of multifunctional panels 150 according to the invention. Structurally, the panel 150 comprises a central core comprised of three layers 151, 152, 153 of superposed and laminated, each comprising a composite of a honeycomb core and thermoformed outer layers. This is encapsulated in a much larger layer 154, itself comprising a larger scale composite with a honeycomb core and thermoformed outer layers. The cells of this honeycomb are filled with a for example cementitious or other inert or refractory filler 155. The upper and lower outer layers of the panel each comprise two laminated layers 156, 157 at the top and 158, 159 at the bottom, and an outer skin 160, 161 respectively on the upper and lower surfaces.

The panel 150 is advantageously used as a wall or roof panel in building, and arranged so that the upper surface skin 160 is exposed externally of the building. The voids in the honeycomb core of layer 156, immediately within the outer skin 160 of the panel have water circulating through them, such that the water is heated by incident solar radiation, and circulated to the voids in the core of lowermost layer 159, immediately within the inner skin 161 of the panel, so that the heat of the water can be radiated to the volume within the building.

The next layer inward, 157 forms an insulative layer, the voids within the layer being at least partially evacuated, and the structure being composed of low heat conductivity and/or reflective materials.

The material 155 in the spaces of the large scale layer 154, may comprise a concrete-type material, which may contain reinforcing inclusions of e.g. metal including as a security measure sharp objects such as fragments of blades. In an alternative, these spaces could be used to store captured rain water.

The inner core layers 151, 152 and 153 comprise a sandwich with outer insulative layers 151, 153 of vacuum or partially evacuated volumes, and a water storage volume, which stores water between the solar heating zone in layer 156 and the radiating zone in layer 159.

The layer 158 provides spaces for accommodation of ‘services’ such as electrical supply conductors 162, telephone or computer leads, and circulation of domestic water supply, ducting for vacuum cleaning services, leads for audio speakers, and so on.

The above examples are by no means exhaustive of possible apparatus or product structures. In the handling of the materials, a continuous film or other web feed may need to be accommodated to an intermittent batch moulding step and this may be done by allowing for a slack to accumulate when the moulding step takes place, to be taken up and fed quickly to the press in the next feeding step.

Provision may be made to coat the outer films on their outer surfaces, and then to rotate them through 180° so that their coated faces are presented inwardly when the films are brought to join the core structure at the forming press.

Provision may be made for varying the thickness of a coating so that articles having various thicknesses as required, e.g. to provide a reinforcement where required, leaving non-stress or load bearing parts of minimal thickness. This may be effected by suitable programming of spray stations.

The articles produced may be generally flat panels, but can also be contoured or “three dimensional” articles.

The apparatus and method of the invention may be adapted to the production not only of doors, or wall panels, but also to produce constant profile parts such as skirting boards and dado rails, roof panels and the like.

The voids in the structures can be isolated or alternatively interconnected, and some voids in a panel may be interconnected allowing for circulation of water as a heating or cooling fluid or for use as a solar energy collecting panel, and at the same time provide other voids which are isolated to act as conduits for circulation, or guides for electric power conductors or telephone and computer leads.

Not only may the panel be made of fire retardant material, due to for example the high filler content of the preferred polyurethane material but also due to the incorporation of intumescents, but also may function as an active fire suppressant if the voids are filled with water for normal use as a heating and/or cooling radiator, since on burn-through to the core, the water content will be released to help to suppress the fire. The intumescent may be applied to the skin with a filler e.g. by spraying. The filler will hold the intumescent together in a fire situation, rather than “flashing off”.

The edges of the panels or other elements may be reinforced with glass fibre edge pieces impregnated with resin, and are also preferably made to be fully interlocking with each other so that structures may be assembled using the elements quickly and easily.

Panels in accordance with the invention may be interconnected in any known satisfactory manner, but can be made to be self jointing. The panels may for example each be formed with a double core, comprising two layers each composed of rectangular sectioned ‘honeycomb’ channels, arranged at mutual right angels so that the channels of an upper layer extend transversely with regard to those in a lower layer. To effect a joint, two such panels may each be partially cut away, removing an end part of one core layer and the overlying outer layer, forming complementary steps which can be overlapped, and joined by adhesive thermal welding or using fasteners.

In another jointing method, panels may be interconnected using dove-tail cross-sectioned grooves in a first panel surface, and corresponding cross-sectioned projections on the second panel, to engage thereon. In plan the grooves may provide widened and constricted zones, and the projections be discontinuous and of lesser length than the widened zones, so that they may be inserted into the widened zones, and displaced towards the constricted zones, the latter and the corresponding ends of the projections being V-shaped in plan, converging towards the constructed zone. The second panel may be placed on the first panel, with the projections in the widened zones, and secured by moving the panels relative to each other, so that the projections are slid into engagement with the converging parts of the grooves.

Materials other than the ones described by way of example may be used in the construction of the elements or components, and it is not excluded that in addition to other plastics, preferably thermoplastics metal components may be included, as reinforcement or as security or electrical or thermal conductors.

In the methods described, the cores are used as a carrier for composite materials such as polyurethane components. These are coated on the outer faces of honeycomb structures provided by the cores, leaving the interiors free to perform functions e.g. as described in relation to FIG. 8. The resins may be grown on the surfaces in a continuous or discontinuous manner. Each core or twin sheet honeycomb structure is coated with different resin combinations to meet the different technical requirements of each layer of the complete structure.

The reinforcement between the twin sheet layers may comprise a sprayed chopped fibrous material or a woven mat of say polypropylene or polyester coated glass or natural fibres. Being thermoplastic, these will fuse with other components of the structure under heat and pressure in the process of manufacture.

The voids described in some embodiments can be used to carry air through or around the panels. They can also be designed to capture air movement or wind from outside the structure and transmit this air movement to small (down to say 50 mm diameter) wind turbines contained with the honeycomb cores. These turbines may be mounted close to the face of the panels, or hidden from view in the ridge or eaves of a building. A single building might contain thousands of these small turbines all linked to produce power.

1. A method for making a component comprising making a continuous or discontinuous core, and feeding the core between the facing surfaces of two continuous films, the facing surfaces having both been coated with bonding material and thermoforming the films and core together, the films providing outer layers, the core comprising two core layers, each core layer comprising rectangular sectioned honeycomb channels arranged at mutual right angles such that channels of an upper layer extend transversely with respect to those in a lower layer.

2. A method according to claim 1, further comprising:
providing a second component formed in a similar manner to the first component; and
removing an end part of one layer and the overlying outer layer of each of the first and second components thereby to provide complementary steps of the first and second panels which can be overlapped.

3. A method according to claim 1, comprising overlapping the complementary steps to form a joint between the first and second panels.

4. A method according to claim 3 further comprising joining the first and second panels by adhesive thermal welding or using fasteners.

5. A method according to claim 31, wherein the core is formed by initially corrugating two webs in such a way that the resulting core provides voids connected by the webs.

6. A method according to claim 5, wherein air pressure is applied through a gap forced between the webs into the voids, which are expanded thereby until the sidewalls abut each other to provide a panel comprising an internal void, subdivided by internal partitions.

7. A method according to claim 5, wherein a partial vacuum is applied between the core and outerskins such that they are held in intimate contact with the core during heating and moulding and cooled to maintain the structure of the core during heating and moulding.

8. A method according to claim 1, wherein the films comprise polypropylene, or polyethylene terephthalate (PET) film, and the core or core components are formed from sheets of thermoplastic material coated with a polyurethane polymer.

9. A method according to claim 8, wherein the thermoplastic material contains a high filler content of refractories, such as CaCO₃ or CaMgCO₃ or BaSO₄.

10. A method according to claim 8, wherein the thermoplastic material is reinforced with long staple glass fibres.

11. A method according to claim 8, wherein the thermoplastic material includes an intumescent.

12. A method according to claim 1, wherein the films include with an intumescent coating applied to include a filler with the intumescent.

13. Apparatus for making components by a method according to claim 1, including means for feeding a core structure between a pair of outer films, and a thermoforming press for thermoforming the films and core into an article.

14. Apparatus according to claim 13, comprising two or more thermoforming presses, each arranged to join at least two plastics webs together, to form a respective core structure, the presses being arranged in series or in parallel, and a final press where the core elements brought together as a multilayer core structure, between the outer films, wherein the thermoforming press is adapted to produce a core characterized by voids wherein a space is present between said sheets, connected by webs wherein said sheets are pressed together.

15. (canceled)

16. Apparatus according to claim 14, wherein said press comprises a top platten and a bottom platten, each provided with a moulding surface having ribs and channels, and disposed so that said rib will when the plattens are closed, abut these in the other plattens.

17-26. (canceled)

27. A method according to claim 1, further comprising providing a dove-tail cross-sectioned groove in a surface of the first panel and a corresponding cross-sectioned projection on a third panel, the projection being arranged to engage the groove thereby to join the first and third panels together.

28. A method according to claim 27, wherein a plan view of the groove of the first panel provides widened and constricted zones, the projection of the third panel being discontinuous and of lesser length than the widened zone such that the projection may be inserted into the widened zone and displaced towards the constricted zone, the constricted zone and the corresponding end of the projection being V-shaped in plan, converging towards the constricted zone.

29. A method according to claim 28, comprising inserting the projection of the third panel into the widened zone of the first panel and moving the panels with respect to one another such that the projection is displaced towards the constricted zone, whereby the projection is slid into engagement with the constricted zone.

30. A method according to claim 1, wherein the core is fed as discontinuous core elements, which are inserted between the films by manipulation means.

31. A method according to claim 1, wherein the core is produced in a preliminary step, by bringing together two webs of thermoplastic material coated with an adhesive and thermoforming or pressing said webs to produce a cellular core structure containing voids, wherein optionally a plurality of such cores are produced in series or in parallel, and introduced between said films together to produce a multilayered core structure.

32. A panel comprising a core provided between facing surfaces of two films providing outer layers, the core comprising two core layers, each core layer comprising rectangular sectioned honeycomb channels arranged at mutual right angles such that channels of an upper layer extend transversely with respect to those in a lower layer.

33. A panel according to claim 32 having an end part of one core layer and the overlying outer layer removed thereby exposing rectangular sectioned honeycomb channels of a remaining core layer.

34. A panel according to claim 32 having a dove-tail cross-sectioned groove in a surface of the panel arranged to engage a corresponding cross-sectioned projection of a further panel, the projection being arranged to engage the groove thereby to join the panels together.

35. A panel according to claim 34 in combination with said further panel, wherein in plan view the groove of the further panel provides widened and constricted zones, the projection being discontinuous, and of lesser length than the widened zones such that the projection may be inserted into the widened zones and displaced towards the constricted zone thereby to join the panels, the constricted zone and the corresponding edge of the projection being V-shaped in plan, converging towards the constricted zone.

36. A structure comprising first and second panels being panels according to claim 35, the remaining core layers of the respective first and second panels being provided in an overlapping configuration whereby a joint between the panels is provided.
